(19) United States
(12) Patent Application Publication
(10) Pub. No.: US 2024/0152948 A1
(43) Pub. Date: May 9, 2024

(54) SYSTEMS AND METHODS FOR USER DATA COLLECTION WITHIN AN AUGMENTED REALITY GAME

(71) Applicant: Christopher FARAGUNA, Harrisburg, PA (US)

(72) Inventor: Christopher Faraguna, Harrisburg, PA (US)

(21) Appl. No.: 18/549,892

(22) PCT Filed: Mar. 11, 2022
(86) PCT No.: PCT/US2022/020067

§ 371 Date: Sep. 8, 2023

(51) Int. Cl. G06Q 30/0207; A63F 13/211; A63F 13/213; A63F 13/216; A63F 13/335; A63F 13/424; A63F 13/533; A63F 13/61; A63F 13/65; A63F 13/80; G06Q 30/0251

(52) U.S. Cl. CPC G06Q 30/0209; A63F 13/211; A63F 13/213; A63F 13/216; A63F 13/335; A63F 13/424; A63F 13/533; A63F 13/61; A63F 13/65; A63F 13/80; G06Q 30/0271; A63F 2300/8064

(57) ABSTRACT

In one aspect, a method for collecting user data through an augmented reality game is disclosed. The method comprises deploying an augmented reality geolocation treasure hunt game as a mobile application on a mobile computing device. Then beginning a geolocation treasure hunt game and loading user parameters of at least user location, user profile status, and user stored credentials. Next, generating a series of questions that when answered provide clues to the location of the next objective on the geolocation treasure hunt game, wherein the series of questions is in the format of a four square decision matrix. Next, collecting user information from the responses to the generated series of questions. Lastly, granting access to the reward based on at least the user's coordinates at the reward location.

### CROSS-REFERENCE

This application claims priority and the benefit of US. Provisional Patent Application No. 63/160,170 filed on Mar. 12, 2021, and titled “Systems and Methods for User Data Collection within an Augmented Reality Game.” The entire disclosure of which is incorporated herein by reference.

### FIELD

The present disclosure relates to computer implemented systems and methods of providing an augmented reality game experience in which a reward based system drives user participation and collection of user data.

### BACKGROUND

The popularity of mobile computing devices, such as smart phones, smart watches, and smart glasses has continued to drive new mediums of entertainment for users. When these devices are equipped with new sensors to provide augmented reality experience, users acquire the benefit of visually detecting changes in and around their environment. This possibility opens a whole new paradigm for digital and gaming entertainment as well as the capability to acquire user preferences and experiences through interaction within a gaming environment.

The history of augmented reality is storied, inventors have strived to improve a user's experience with their surroundings by implementing new and improved hardware devices. In 1838, Charles Wheatstone invented the stereoscope, which was the first attempt to render three dimensional objects. In 1957, Morton Heiling invented the Sensorama, which allowed users to experience a blend of sounds, visuals, motion stimuli and more. In 1968, Ivan Sutherland invented an early version of a head mounted display unit. In 1974, Myron Kruger developed Videoplace, a projection-based augmented reality where users did not require the use of a wearable. In 1986, Ron Feigenblatt described what we know as augmented reality today, a “magic window” (mobile augmented reality) or the use of a small flat panel display positioned and oriented by the hand to aid the user in interpreting their surroundings. Continuing in advancements, in 1999 the US Naval Research Laboratory launched a decade-long research project on Battlefield Augmented Reality Systems (BARs) to improve situational awareness for soldiers in urban environments. Most recently, augmented reality has found its way to a plethora of devices such as smart glasses, smart phones, smart watches, and headsets or other equipment that allows enhancements with a user's surroundings.

Advancements of technologies in augmented reality has allowed users to experience immersive environments with relatively affordable hardware. The new experiences bring the ability to analyze new perspectives and to gather new forms of data based on user's experience with their environment. Further, new incentives are created that drive consumer/user demand and provide a new gateway for collecting information that contains precise user information.

As such, there is a need to combine new technologies with methods to collect user information so that the information can be tailored and customized to merchant offerings. The disclosure herein provides technology to enable user interaction that drives user information so that merchants can in turn target offerings to customers that are likely to buy their products and likely to be based within a similar geographical location.

### SUMMARY

In one aspect, a method for collecting user data through an augmented reality game is disclosed. The method comprises deploying an augmented reality geolocation treasure hunt game as a mobile application on a mobile computing device. Next, beginning a geolocation treasure hunt game, wherein beginning initiates an instance of the game based on the user parameters of at least user location, user profile status, and user stored credentials. Next, generating a series of questions that when answered provide clues to the location of the next objective on the geolocation treasure hunt game, wherein the series of questions is in the format of a four square decision matrix. Next, collecting user information from the responses to the generated series of questions. Next, processing and generating additional questions based on the collected user information from the responses to the generated series of questions. Next, coordinating with the GPS on the user mobile computing device configured with the mobile application the user coordinates in relation to the objective. Lastly, granting access to the reward based on the at least one parameter of the user's coordinates at the reward location.

In another aspect, a system for collection of user data within an augmented reality game. Wherein the system comprises a mobile computing device. The mobile computing device comprises (1) a processor, configured to process an augmented reality game; (2) a graphics processing unit, configured to handle the visual rendering; (3) a depth sensor, configured to measure depth and distance; (4) a proximity sensor, configured to measure how close or far away an object is; (5) an accelerometer, configured to detect changes in velocity; and (6) a light sensor, such as an ambient light sensor, configured to measure light intensity and brightness. The system further includes a configurable augmented reality software application, configured on the mobile computing device, wherein the configurable augmented reality software application is configured with a question and response four square decision matrix. As well as a distributed computing environment, configured to receive and transmit instructions and deploy the configurable augmented reality software application. Lastly, a networked computer, configured to communicate to the distributed computing environment.

In further aspects, a method for collecting data through a mobile application is disclosed. The method comprises initiating a mobile application on a user mobile computing device. Next, presenting the user with a four square decision matrix within the mobile application. Next, selecting by the user at least one option from the four square decision matrix. Next, collecting information from the user selection, wherein collecting acquires at least the user's geolocation and the selection made from the four square decision matrix. Next, generating a new question based on the selection and previous selections by the user on the four square decision matrix. Lastly, rewarding the user after a set count of responses.

These and other embodiments are described in greater detail in the description which follows.

### BRIEF DESCRIPTION OF THE DRAWINGS

Many aspects of the present disclosure will be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views. It should be recognized that these implementations and embodiments are merely illustrative of the principles of the present disclosure. In the drawings:

FIG. 1 illustrates an example embodiment of a method and system for collecting user data through an augmented reality game;

FIG. 2 illustrates an example mobile computing device;

FIG. 3 illustrates a computing device;

FIG. 4 illustrates a flow chart of an example method for collecting user data through an augmented reality game;

FIG. 5 illustrates an example of computing devices connecting to a network supporting the augmented reality game;

FIG. 6 illustrates an example of data processing from data collected through an augmented reality game;

FIG. 7 illustrates an example flow chart of an expanded four square decision matrix;

FIG. 8 illustrates an example of a close up of the flow chart from FIG. 7 of a four square decision matrix;

FIG. 9 illustrates an example of a flow chart for a mobile application as disclosed herein;

FIG. 10 illustrates an example of a user interface for an augmented reality game wherein the four square decision matrix may be presented;

FIG. 11 illustrates an additional example of a user interface for an augmented reality game;

FIG. 12 illustrates an additional example of a user interface for an augmented reality game, wherein the user interface is showing aspects of the calibration of the augmented reality experience;

FIG. 13 illustrates an example of a reward system within the user interface for an augmented reality game;

FIG. 14 illustrates an example a reward within the user interface for an augmented reality game;

FIG. 15 illustrates an example of a backend web application for administering a mobile application, such as an augmented reality game.

FIG. 16 illustrates an example of data flow and processing for a mobile application, such as an augmented reality game.

FIG. 17 illustrates a flow chart and basic interaction of natural language processing for a mobile application, such as an augmented reality game.

### DETAILED DESCRIPTION

Implementations and embodiments described herein can be understood more readily by reference to the following detailed description, drawings, and examples. Elements, apparatus, and methods described herein, however, are not limited to the specific implementations presented in the detailed description, drawings, and examples. It should be recognized that these implementations are merely illustrative of the principles of the present disclosure. Numerous modifications and adaptations will be readily apparent to those of skill in the art without departing from the spirit and scope of the disclosure.

Augmented reality on the hardware side requires at least a mobile computing device equipped with a processor, and likely also a graphics processing unit (GPU), and sensors. The processor, as discussed later on, is the processing unit of the device and most often determines the speed and/or rate of computation on the device. The GPU most often handles the rendering on the display of the mobile computing device, and requires high performance architecture to superimpose the digital image on the environment. Lastly, there is an array of sensors, most often including a depth sensor, a gyroscope, a proximity sensor, an accelerometer, a light sensor, a camera sensor (front and/or rear facing), and in some embodiments a LIDAR sensor. The depth sensor measures the depth and distance of an environment. The gyroscope is utilized to detect the angle and position of the mobile computing device. The proximity sensor is used to measure how close or far an object within the environment is. An accelerometer is used to detect changes in velocity, movement, and rotation. The light sensor allows measuring of the intensity of light. The camera sensor, allows an image to be generated of the environment, and LIDAR (Light Detection and Ranging) is a remote sensing method that may operate in complete darkness and with a high degree of precision by sensing pulsed laser light that is reflected from the environment, thus enabling a dimensional view of the environment. LIDAR requires an advanced laser system and a detection system enabled on the mobile computing device.

Augmented reality on the software side requires at least three components. The first being environment understanding, which allows the mobile computing device to detect prominent feature points and flat surfaces to map the surroundings. This allows the placement of virtual objects on the mapped surfaces. Second, motion tracking is required, wherein the mobile computing device determines its position relative to the environment. Thereby allowing virtual objects to be placed in designated locations and have reaction to designated locations. Lastly, is light estimation, which gives the mobile computing device the ability to perceive the environment and the environments current light intensity. This allows the virtual objects to be placed in similar lighting conditions.

Natural language processing and related technologies such as text analysis, speech analysis, speech recognition, Q&A, are an area of computer science and artificial intelligence that seek to help computers understand language. The technology is utilized to drive automated interactions through a series of techniques. First, because of the degree of difficulty in understanding and/or interpreting the meaning of human speech, including things such as variability in spoken language, tonation, dialect, etc. the problem is considered a Non-Polynomial (NP) Hard type of problem. Therefore, the goal is to keep ambiguity to a minimum and process the structure of the sentence from a natural language. Thereby, incorporating artificial intelligence to parse the disambiguation and utilize machine learning with trained models to identify the correct parts of speech to formulate into a sentence.

Syntactic analysis and semantic analysis are two primary techniques that lead to the understanding of natural language. Syntax is the grammatical structure of text and semantics is the meaning the speaker is attempting to convey. Syntactic analysis attempts to assign semantic structure to text, thereby identifying nouns, verbs, etc to group the structure of the sentence. Semantic analysis attempts to understand the meaning of the text.

Parsing is one technique utilized to syntactically analyze text. Parsing refers to the analysis of a sentence by a computer into its constituents, which results in a parse tree showing their syntactic relation to one another in visual form, which can be utilized for further processing and interpretation. Stemming is another technique, that originates from the morphology and information retrieval often used in pre-processing techniques. Stemming is the process of reducing words to their “stem,” thereby removing prefixes and affixes and focusing on the core of the word.

Text segmentation is the process of transforming text into meaningful units such as words, sentences, and topics. Text segmentation includes methods such as named entity recognition, relationship extraction, and sentiment analysis. Tokenization is one aspect, wherein spoken words that are converted are tokenized by indexing into a dictionary. The tokenized words are often normalized with standard formats for the region. Next, sequencing turns the tokenized words into sentence sequences. The sequenced text can be applied to a classifier wherein sentiment or other features may be extracted. Further technologies include deep learning technologies and employ additional packages and libraries such as NLTK 3.5 https://www.nitk.org/; scikit https://scikit-learn.org/stable/; and TensorFlow https://www.tensorflow.org/. In examples such as deep learning and the application of convolutional neural networks, the word encodings are feature mapped through a convolutional layer, a polling layer applies dimensionality reductions, typically through principal components analysis, independent components analysis, or other dimensionality reduction, and a classification is formed at the output layer.

In one aspect, a mobile game includes a treasure hunt, and further includes a question and answer session to grant tokens, points, or otherwise to enter free raffles for prizes. In such aspects, a four square decision matrix is employed within the question and answer and may utilize techniques such as natural language processing to recognize speech, parse and tag spoken language, develop an ontology, and generate a response to the user. In even further aspects, the speech recognized itself is classified and stored based on the user, and such data is applied with additional tags within the four square decision matrix. In further aspects, the treasure hunt game, wherein augmented reality is applied, is further enhanced with natural language processing, allowing a user to step through the game and interact with the application utilizing voice commands, of which may be utilized in the four square decision matrix, or to provide interaction to progress through the treasure hunt.

In another aspect, a user is presented with, upon opening the mobile application, a series of questions in the format of a four square decision matrix. The four square decision matrix includes four squares that represent a different answer selection to the question. Upon a user selecting an answer, the four square decision matrix promulgates an additional four square decision matrix, and so on. By further parsing down the ladder of a four square decision matrix more user information is revealed and preferences may be ascertained in a whole host of goods and services. For example, the four square decision matrix allows for data collection around a specific category such as brand, product, interest, and more, and allows for continual linking of four square matrices to form a knowledge net or a knowledge graph. Rewards, such as points or progress within the game is often added to responses to encourage further user participation. The knowledge net or graph formed by the four square decision matrix may be parsed through various means and the collected data organized within a relational, semi-relational, or unstructured database wherein further modeling of the data may occur. The responses to the four square decision matrix form a knowledge graph that allows affiliation to a merchant database wherein merchants may have access to the modeled data and allow further insights into specific brands. For example, retailers or merchants may be associated and the four square matrix may provide insight, wherein the game may allow or encourage visiting retailers in which responses provided to the four square matrix are positive or aligned with the merchant's goods or services. For example, Starbucks™ may purchase user knowledge from the four square matrix for user's playing the augmented reality game that have indicated within the four square matrix a preference for coffee.

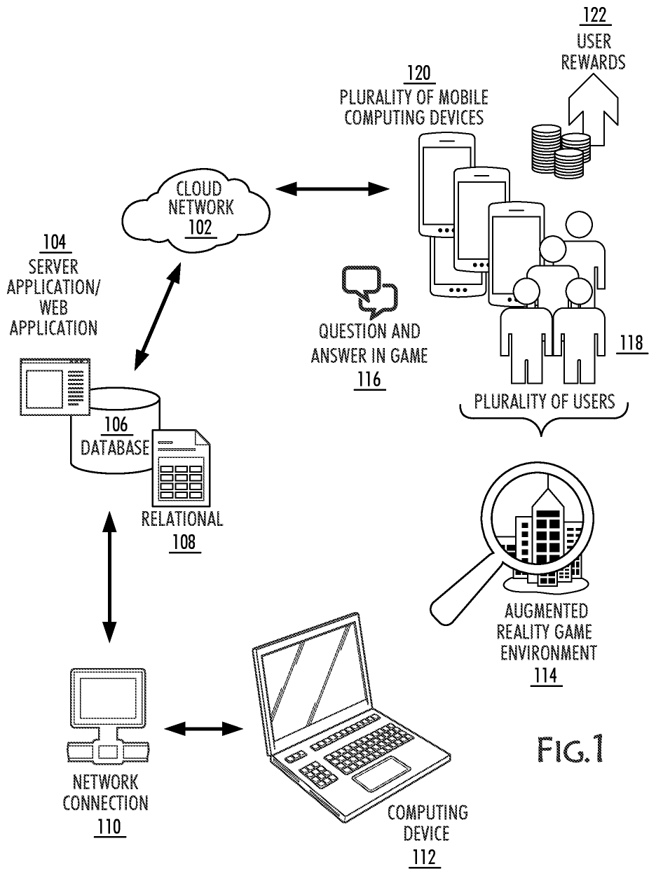

Referring now to FIG. 1. In the example embodiment of FIG. 1 a system and method is disclosed for deploying an augmented reality treasure hunt game on a mobile computing device, and the other hardware and software components involved in delivering the mobile application. In other aspects, a game may not involve augmented reality, but take place through geolocation or through the user interface of the mobile computing device. In other aspects, the game may be a scratch off game, or a raffle, or other game that is then combined with a geohunt or augmented reality treasure hunt game. Those skilled in the art will recognize that various mini-games may be applied within the augmented reality treasure hunt game, all of which may add to the experience and functionality of the mobile application incorporating the four square decision matrix for mining user preferences.

In the example an augmented reality game environment is a given geographical location in which the game is played. Often times stores such as merchant shops, including brick and mortar retail locations, may be located at or near the geographical location. Further features include parks, indoor spaces, sidewalks, and other locations. The server application or web application allows an administrator to structure a particular game within a geographical location, or augmented reality game environment by placing points and deriving questions such as those present in the four square decision matrix, or other questions that allow a user to advance to the reward or goal state. The reward or goal state may be a coupon or discount provided at a retail location based on user preferences determined from the four square decision matrix. Additional four square decision matrix questions may be presented at any time and the reward may be linked to a raffle or other offering such as a discount or coupon.

The four square decision matrix is a question and answer or question and response system that allows proliferation of additional questions and answers based on previously stored answer and a set of choices. The four square decision matrix, in one embodiment provides brand decision question and answer selections, and may be further linked to a user's previous responses, location, and additional parameters such as age, sex, height, weight, to name a few. In additional embodiments the four square decision matrix provides product preference question and answer selections, and similar to brand decision allows intuitive question formatting through previous responses or other parameters. In yet another embodiment the four square decision matrix has hobby preference, or other data collection preference that is capable of adaption to a four square decision matrix. Another aspect of the four square decision matrix, is the ability to automatically link a user's preference across a wide variety of questions, thereby developing a more accurate model of the user.

A sample four square decision matrix may present a question on the user interface that requests—What kind of beverage do you prefer? Wherein the user is presented with four options, in this example, water, alcoholic beverages, juice, and soda. The response if water is selected leads to a new four square matrices that depend upon the original four square matrix, the new question may be—What type of water do you drink? Wherein prepopulated answer selections arrive, such as tap, Poland spring, nestle, not listed, each answer selection spawns a new four square matrix, wherein the answer form a knowledge net with intimate knowledge of a user preferences and selections. The knowledge database may then have various metric and algorithms applied, such as a neural network that may further parse the information for hidden connections.

In other aspects, a treasure hunt game is disclosed within a mobile application, wherein the mobile application may be on smart glasses or AR goggles or other device worn over a user's eyes that allow interaction with an augmented reality experience. In some aspects, the treasure hunt game may be started by spending points, wherein the points are acquired by answering questions within a four square decision matrix. In other aspects, to progress along the treasure hunt, to the next objective, a user must respond to a four square decision matrix question. In further aspects, the four square decision matrix may be tied to points or rewards, and further tied to free raffles.

In another aspect, an augmented reality treasure box is placed within the game and it may be accessed by interacting with the interface on a device executing the mobile application. In such aspects, additional awards may be available through interaction with responses to a four square decision matrix that is linked to the augmented reality treasure box. Furthermore, responses to the four square decision matrix may provide clues that lead to additional rewards, wherein the augmented reality treasure box may be located at retail stores and inside offer discounts or promotions.

Continuing in FIG. 1, the question and answer game in one embodiment is within the augmented reality game and provides questions and answers in the form of the four square decision matrix. In other embodiments the question and answer game is in the form of a survey within the web application and on the mobile application that allows users to answer surveys for points, wherein the points may be used to acquire free raffle tickets, and the raffle tickets can be used to enter for prizes such as currency or other prize. In other embodiments the user rewards are based on completing the augmented reality game, wherein points may be rewarded as treasure, those points then can be used for free raffles that enter a user for a chance to win prizes.

In the example, the plurality of users each have a mobile computing device, and together form a plurality of mobile computing devices. Each device may have the mobile application installed through an interface such as Apple's AppStore™ or Google's Play Store™ or other application installer, including a stand-alone installer. The mobile computing devices are most often configured to connect over a variety of communication means, including Bluetooth™, WiFi, Cellular, Radio, and others, including a variety of protocols.

In the example of FIG. 1 the web application is deployed via a cloud network from a server application or web application. Examples of such web application server providers include Amazon Web Services™, Microsoft Azure™, Google Cloud Platform™, and others. The on demand cloud computing platforms allows deployment of the web application across a plurality of users. The cloud computing platform is equipped with access to databases in which to store information supplied by the four square decision matrix. Typical databases include structured and unstructured, wherein structured is in the form of a relational database that is mapped to categories with the four square decision matrix. In an unstructured database, incoming information from the application may be collected from user responses or activities, or even machine generated data. Further, there may also be semi-structured databases like those typically deployed in email applications.

In one aspect, a database contains all the stored and tagged information or data wherein further processing of the data through decision trees or other supervised learning model is applied. In another aspect, a neural network is applied to model the data and gather insights from comparisons of the brand, hobby, or other user preferences. Further insights may be derived from preference and geographical data, leading to additional learning models.

In the example of FIG. 1 the server application or web application may be configured with an administrative portal for aiding in deployment of objectives within the game and for managing the content and data. In one embodiment a computing device connects through a network and establishes administrative authentication, wherein the administrator is granted access to establish a new game, view and edit parameters, and view and access the entire backend system. In other embodiments, the administration may occur over a mobile computing device or over access to the web application.

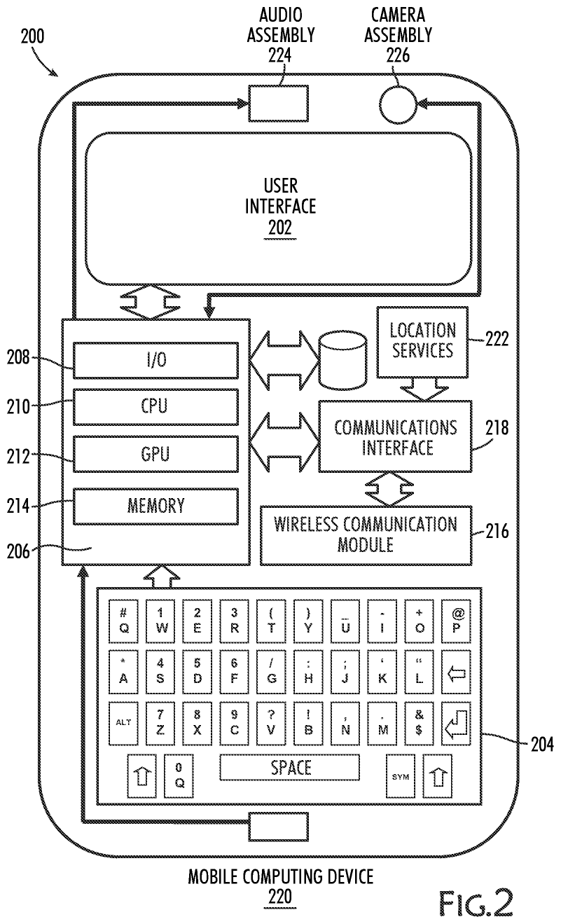

Referring now to FIG. 2. In the example of FIG. 2 a mobile computing device is configured with a user interface wherein the mobile application displays the augmented reality game or otherwise displays the question and response of the four square decision matrix. The mobile computing device is further configured with an audio assembly and a camera assembly, wherein the camera assembly assists with the environment and in accordance with the augmented reality development package or kit, aids in constructing the parameters for the augmented reality aspect. Further, the camera also obtains data that may also be incorporated into decisions within the four square matrix, and may further also be enabled to scan coupons such as that of a QR code or other bar code. The scanner module, in some aspects, is the camera module on the mobile computing device. Further, the camera module may also interpret instructions and transmit information from geolocations or other objectives that allow for further data collection. For example, a user on a geohunt or augmented reality treasure hunt may use the camera to proceed, objects within the camera's view may be classified and stored in a repository, in one example, passing a restaurant may flag that restaurant, the more trips the user makes past the specific restaurant may then bring alerts and other information to the user regarding the restaurants products and services. In such embodiments a merchant database may be established that allows merchants to create accounts and have access to information regarding users who have frequently visited in or around the merchant's location.

Standard features such as a CPU, Bus, GPU, Memory, Communications Adapter, and more are discussed later and are exemplary of hardware features that me be included in devices such as the Apple iPhone™ and Samsung Galaxy™ devices, to name a few. The mobile computing device, in the example embodiment, includes location services such as global positioning services (GPS) that allows for precise user location data to combine with additional features of the mobile application. The wireless communications module, also known as a communications adapter, supplies wireless communications through a variety of standards as previously discussed, and in particular may include such wireless standards as 3G, 4G, LTE, and 5G to name a few Similarly, the use of WiFi, such as WiFi 5 protocol are also capable through the communications adapter.

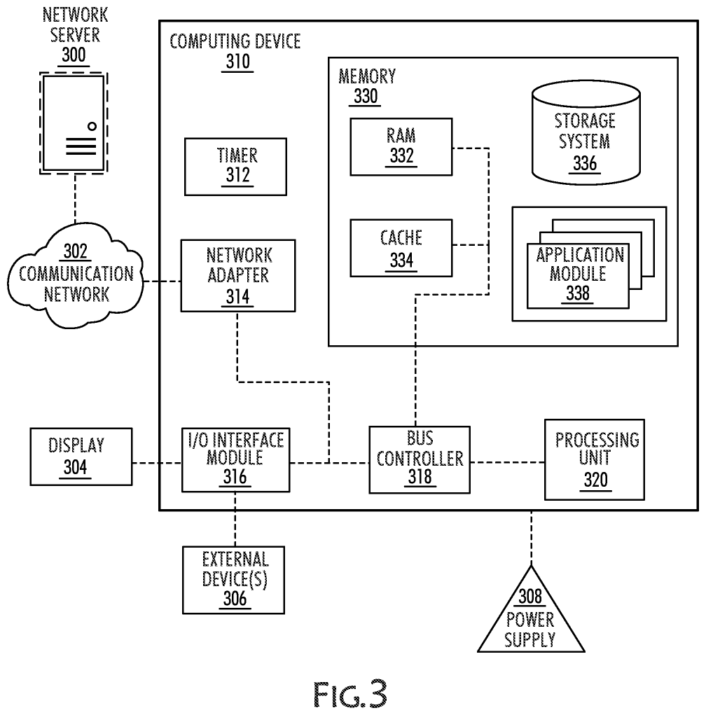

Referring now to FIG. 3. In the example of FIG. 3 a general purpose computing device is disclosed. The general purpose computing device may also be embodied in a mobile computing platform or device such as a smart phone, cellular phone, smart watch, wrist watch, eyeglasses, or AR glasses, to name a few. In other aspects of a general purpose computing device a microcontroller may be adapted for specific elements of the disclosure herein, or even further, a special purpose computing device may form elements of the disclosure. In the example embodiment of FIG. 3, the computing device is comprised of several components. First, the computing device is equipped with a timer. The timer may be used in applications such as applications for generating time delays for battery conservation or to control sampling rates, etc. The computing device is further equipped with memory, wherein the memory contains a long term storage system that is comprised of solid-state drive technology (e.g. NAND) or may also be equipped with other hard drive technologies (including the various types of Parallel Advanced Technology Attachment, Serial ATA, Small Computer System Interface, and SSD). Further, the long term storage may include both volatile and non-volatile memory components. For example, the processing unit and or engine of the mobile application may access data tables or information in relational databases or in unstructured databases within the long term storage, such as a NAND or other SSD. The memory of the example embodiment of a computing device also contains random access memory (RAM) which holds the program instructions along with a cache for buffering the flow of instructions to the processing unit. The RAM is often comprised of volatile memory but may also comprises nonvolatile memory. RAM is data space that is used temporarily for storing constant and variable values that are used by the computing device during normal program execution by the processing unit. Similar to data RAM, special function registers may also exist, special function registers operate similar to RAM registers allowing for both read and write. Where special function registers differ is that they may be dedicated to control on-chip hardware, outside of the processing unit.

Further, disclosed in the example embodiment of FIG. 3, is an application module. The application module is loaded into memory configured on the computing device. The disclosure herein may form an application module and thus may be configured with a computing device to process programmable instructions. In this example, the application module will load into memory, typically RAM, and further through the bus controller transmit instructions to the processing unit. The processing unit, in this example, is configured to a system bus that provides a pathway for digital signals to rapidly move data into the system and to the processing unit. A typical system bus maintains control over three internal buses or pathways, namely a data bus, an address bus, and a control bus. The I/O interface module can be any number of generic I/O, including programmed I/O, direct memory access, and channel I/O. Further, within programmed I/O it may be either port-mapped I/O or memory mapped I/O or any other protocol that can efficiently handle incoming information or signals.

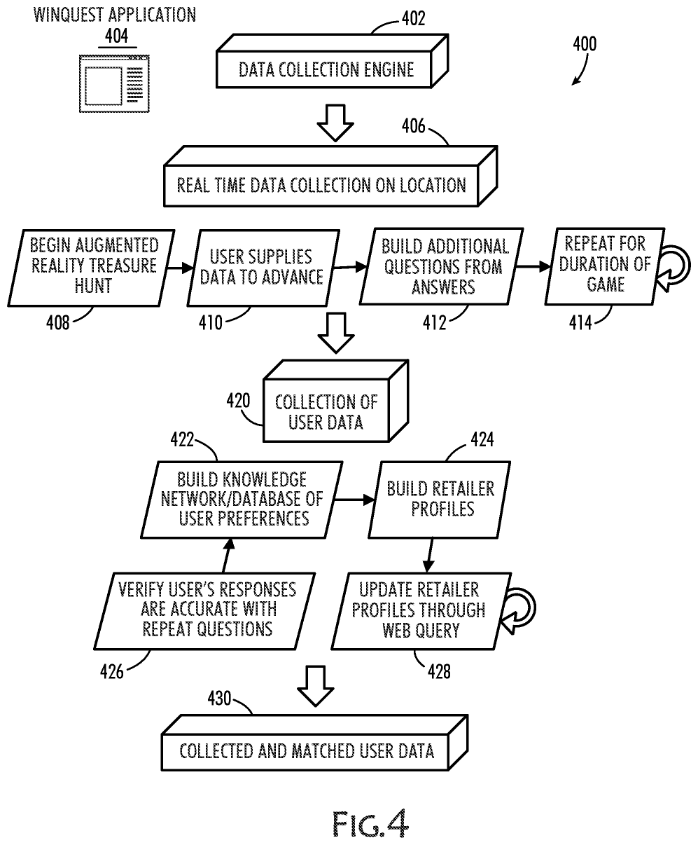

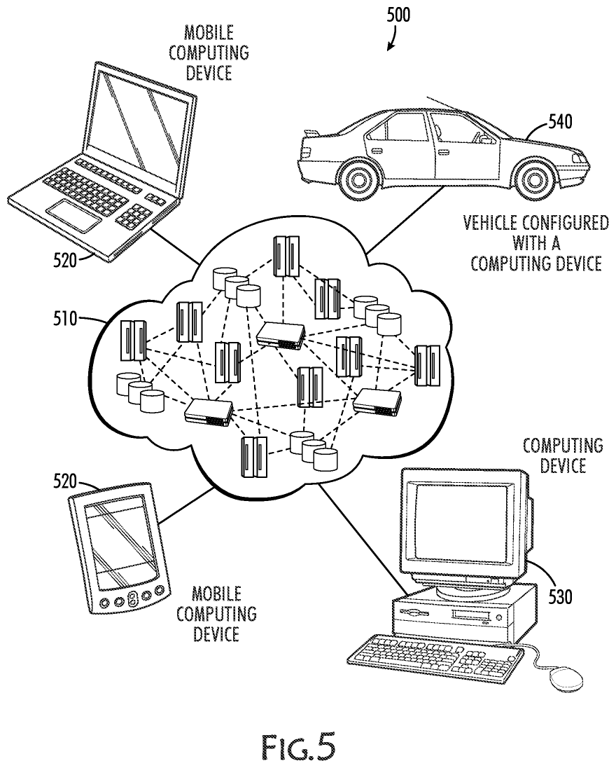

Referring now to FIG. 4, an example embodiment of a flow chart of an example method for collecting user data through an augmented reality game. Wherein the mobile application is launched on a mobile computing device and the data collection engine executes on the CPU of the mobile computing device, being held in memory, and begins real time data collection based on user responses to surveys, such as the four square decision matrix, and as well as through playing the augmented reality game. In one example, the user supplies data from gameplay and at each turn or new geolocation the user supplies answers to the four square matrix for points or for the ability to advance. Such responses are also tagged with the geolocation of the user and other additional parameters such as age, height, weight, and preferences previously stored. Additional questions are built upon the previous corpus of knowledge and such questions propagate future responses. Further, the system includes redundancy and built in validation tests on questions by methods or re-examining former four square decision matrix questions and other means as will be known by those of skill in the art.

Continuing, once the collection of user data is formed and store on a database, as previously disclosed, the user's responses are further validated, and a knowledge network is formed connecting the user preference to gain further insights through mathematical modeling such as supervised and unsupervised learning models, deep learning models, and reinforcement learning models.

Referring now to FIG. 5, an example of computing devices connecting to a network supporting an augmented reality game. In this example, a user may be searching for a geo-hunt, treasure hunt, or other geolocation based game utilizing a vehicle configured with a computing device that allows the game or mobile application to appear on the vehicles user interface, examples include the screen on the center of the dash or other screen wherein the game may show a map and location of stops or steps, as well as provide for question and answers through the four square decision matrix. The networked geolocation treasure hunt offers access to a variety of stationery and mobile computing devices such as augmented reality glasses, mobile phones, smart watches, wrist watches, to name a few. The network is connected to a web server in which the game is deployed to the various devices in a network cloud architecture. Further, in some aspects, the plurality of devices may work together or in coordination for multiplayer geolocation based games, including group questions through a four square decision matrix.

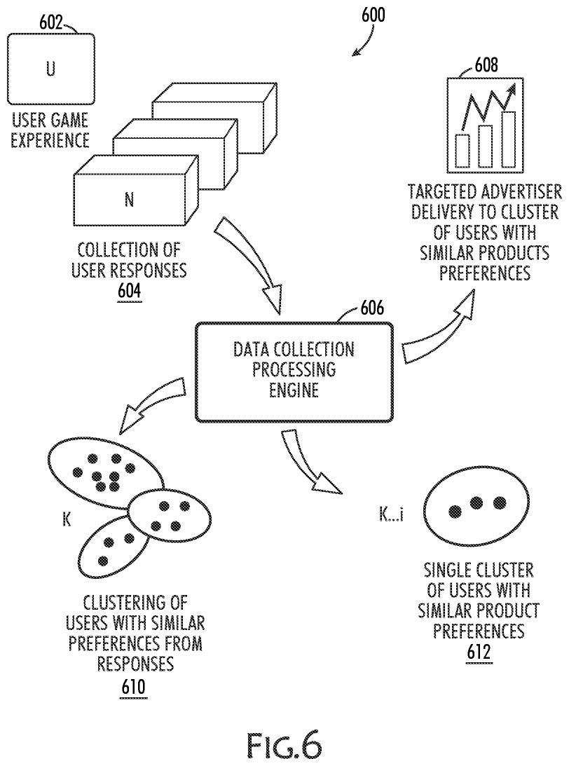

Referring now to FIG. 6, an example of data processing from data collected through an augmented reality game is disclosed. In one aspect the user game experience U yields data from the various four square decision matrix responses that, through the plurality of users, forms the collection of user responses N. The collection of user responses is typically held within a data structure and is capable of being processed through supervised, if labeled, or unsupervised learning techniques. The data collection processing engine houses the main algorithm that executes on the web application or web platform and provides insights into the data collected from the four square decision matrix. In the example, unlabeled data is applied to a clustering algorithm, and forms groupings or clusters K with related information. Each cluster is then mapped through a merchant affiliate program to merchants that specify keywords or concepts that align with the given clusters, wherein the merchants may then use the information and through the mobile application display marketing or advertising items such as store locations, hours, coupons, and deals that are targeted based upon usage of the mobile application and responses to the four square decision matrix.

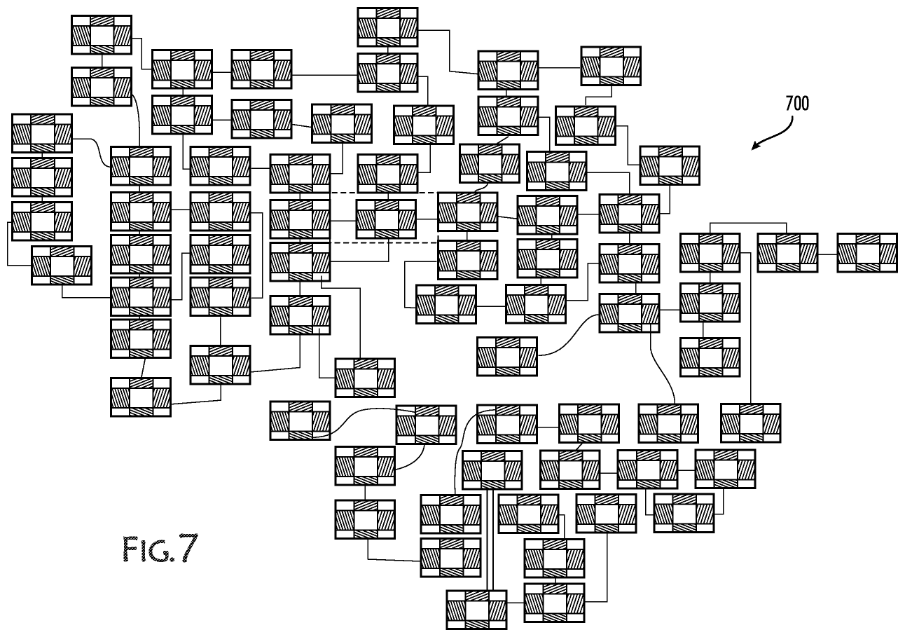

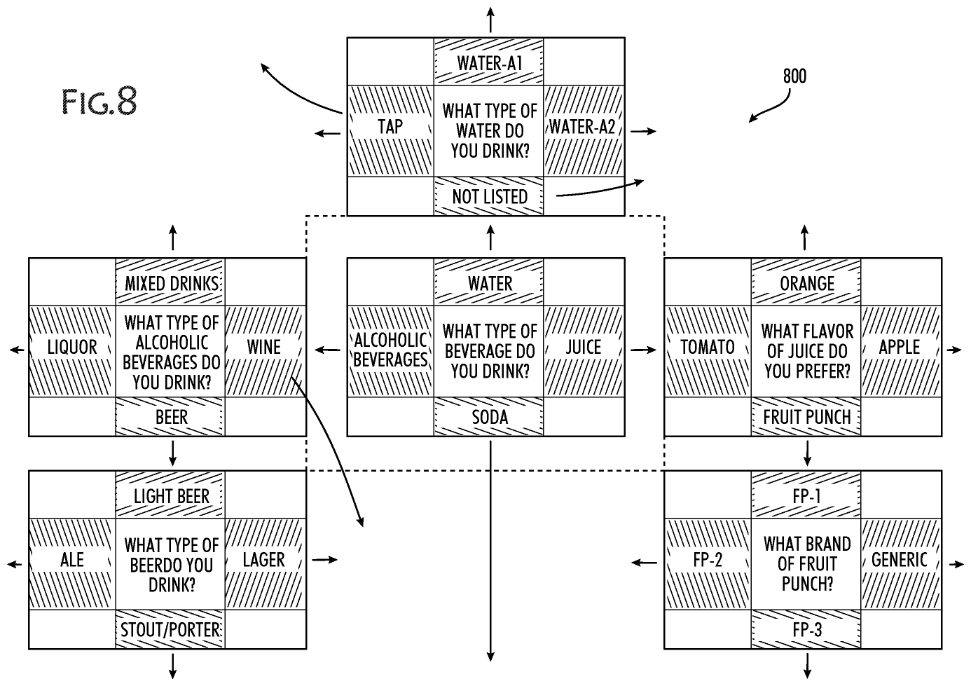

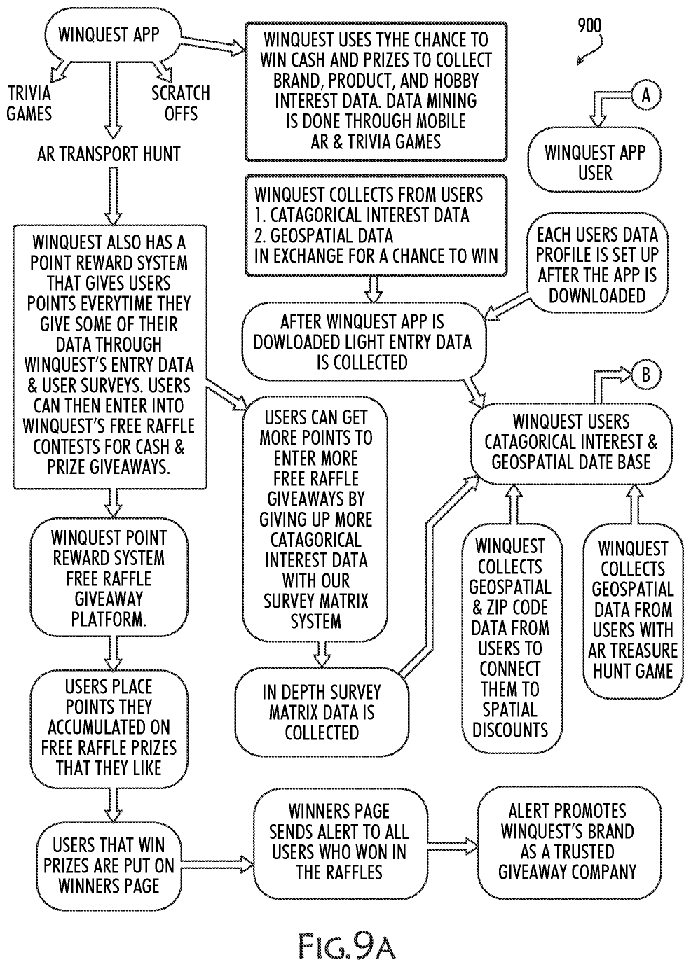

Referring now to FIGS. 7 and 8, example embodiments of an overview of the four square decision matrix are disclosed. In one aspect a graph database is formed from the various questions and responses. In another aspect, the database is a tree based data structure. In yet another, the database forms a relational database with the unique user ID assigned to each user. In another aspect, an unstructured database or a semi-structured database is used. The four square question matrix, in one example, includes a question that propagates four answers. In another embodiment, the question may propagate two answers, or even three answer choice selections, wherein the selections may be redundant or may verify the previous answers, or may further delineate user preference or choice. The responses from the four square matrix decision propagates additional questions based on previous answers and additional factors, such as location, previous games, parameters set within the application such as hobby interests or brand interests.

Additional embodiments of a four square decision matrix include providing narrowing decisions for topics such as brands, hobbies, interests, and personal preference, further allowing for targeted results based on a unique user's preferences. The four square decision matrix may offer rewards such as points, wherein the points may be redeemed for raffles that include prizes such as monetary, services, or goods.

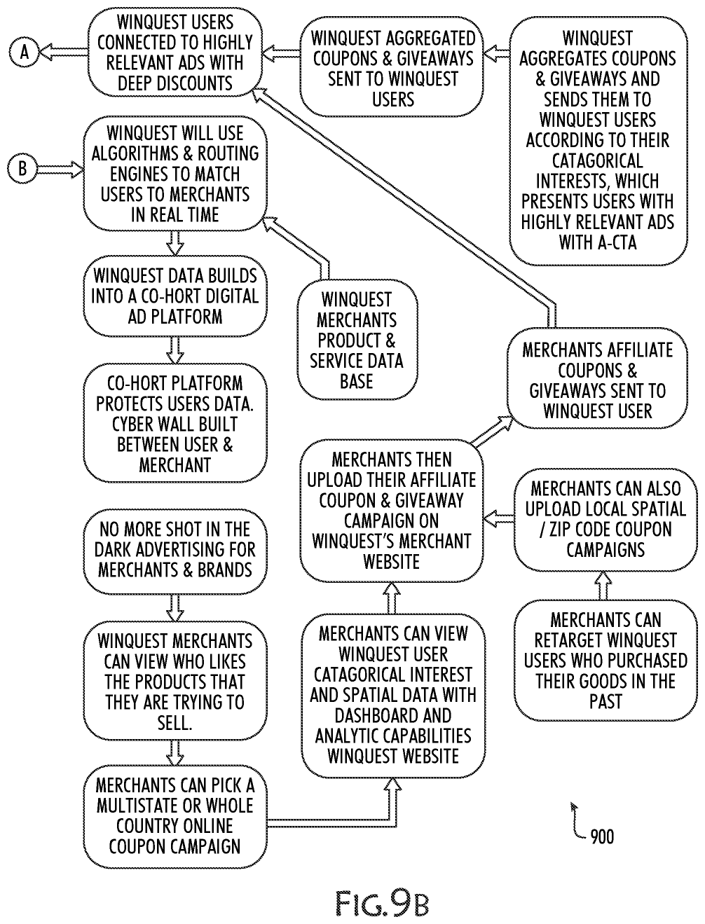

Turning now to FIG. 9, illustrating an example of a flow chart for a mobile application as disclosed herein. Wherein the flow chart indicates aspects of the disclosure provided herein. In the example of FIG. 9, a user begins by opening the WinQuest application on mobile device, the user selects between trivia games, AR treasure hunt, and scratch offs. The purpose of the mini games is to acquire information through the four square decision matrix, wherein the matrix allows users to acquire points to play additional mini games. The points may further be spent to enter free raffles, wherein free requires no currency but allows for points to buy additional chances.

Virtual scratch off tickets are known to those of skill in the art, and are described, for example, in U.S. Pat. No. 10,713,883 to D'Angostino, the contents of which are hereby incorporated by reference. In some embodiments, the system described herein has a pre-recorded content database and a processor that establishes a virtual scratch card game. The processor also randomly determines a plurality of positions in a virtual scratch card grid that correspond to a winning outcome of the virtual scratch card game. In some aspects of these embodiments, the processor searches for a plurality of pre-recorded video clips in the pre-recorded content database such that each of the plurality of pre-recorded video clips displays an event corresponding to the winning outcome. In some aspects, the processor provides the plurality of pre-recorded video clips to a display device that renders the virtual scratch card grid according to a plurality of scratch-off blocks that, when activated, reveal each of the plurality of pre-recorded video clips at each of the corresponding plurality of positions.

In other embodiments, a computer program may have a computer readable storage device with a computer readable program stored thereon that implements the functionality of the aforementioned system. In still other embodiments, a process that utilizes a processor may implement the functionality of the aforementioned system.

The mobile application in the example of FIG. 9 further includes a winner's page, wherein the winners page displays the current list of available winners. Information collected from the users is store in the categorical interest and geospatial database. Wherein the categorical interest and geospatial database may interface with routing engines or additional algorithms to match unique users to merchants in real time. In one example, the real time matching may pop up during a user's treasure hunt experience, offering a coupon to a merchant that is close by in which is highly correlated through algorithmic means to show interest. For example, a user has identified coffee, and expressed Starbucks™ as a preferred vendor within responses to the four square decision matrix. The merchant alert system may alert the user when playing an augmented reality treasure hunt that a Starbucks™ is nearby and a 10% coupon is offered within the interface of the application.

Continuing with FIG. 9, in the example a cohort platform is disclosed in which user's data is protected from merchant access. Further, in the example, the mobile application controls all user's information and provides limited access to merchants for purposes of marketing and advertising. Further, the application interfaces with a merchant product and service database, wherein merchants can utilize the applications four square decision matrix data to build unique marketing platforms, including coupons, realization of users with previous purchases, offer giveaways, and other opportunities to connect with users with known preferences for targeted and highly relevant advertisements.

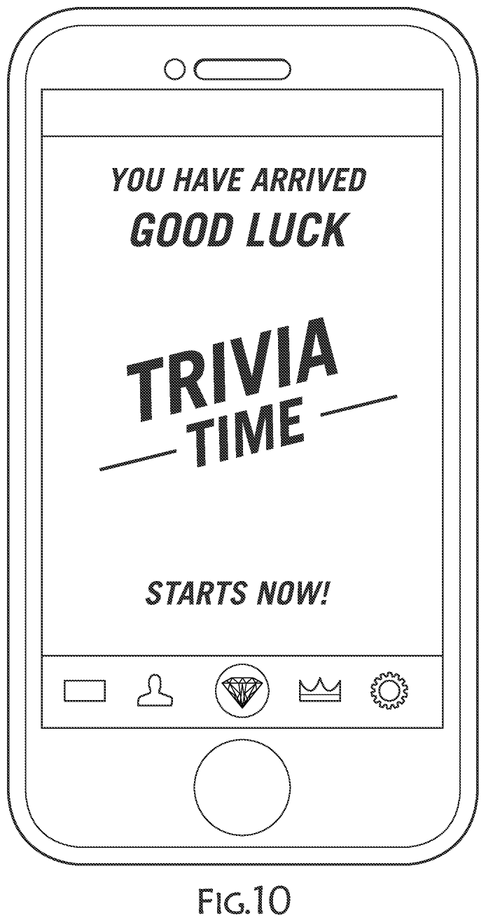

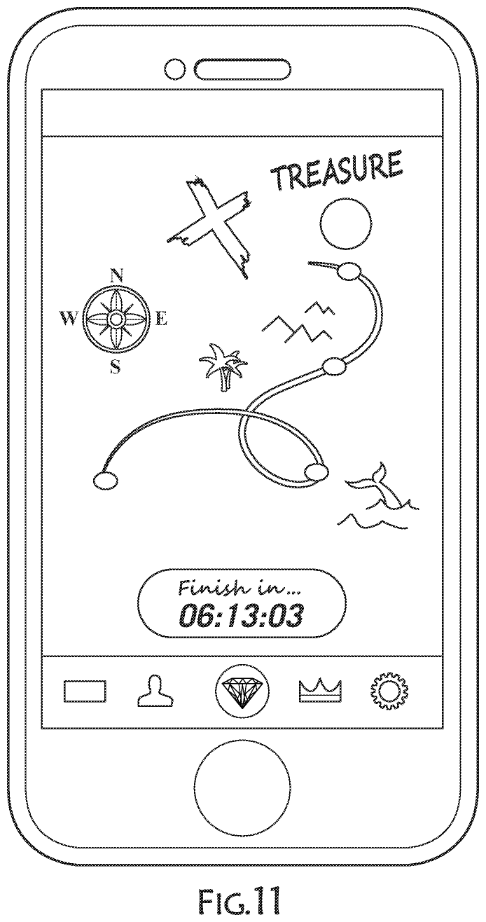

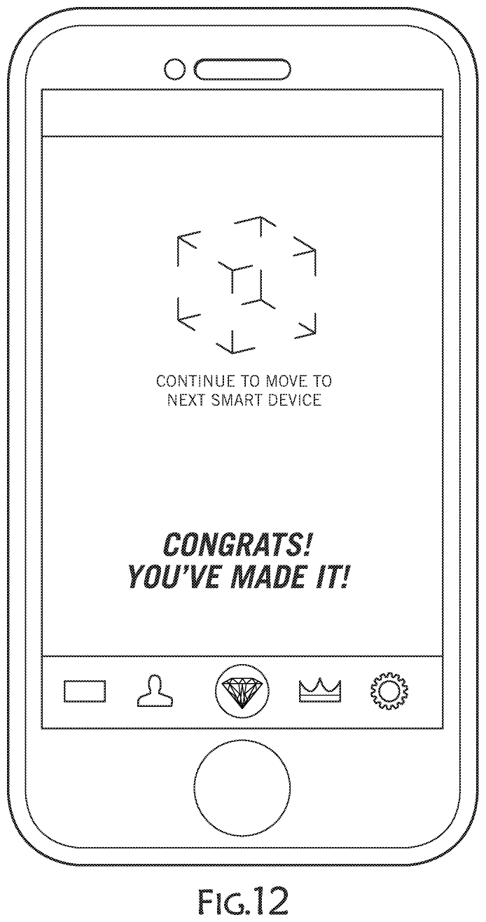

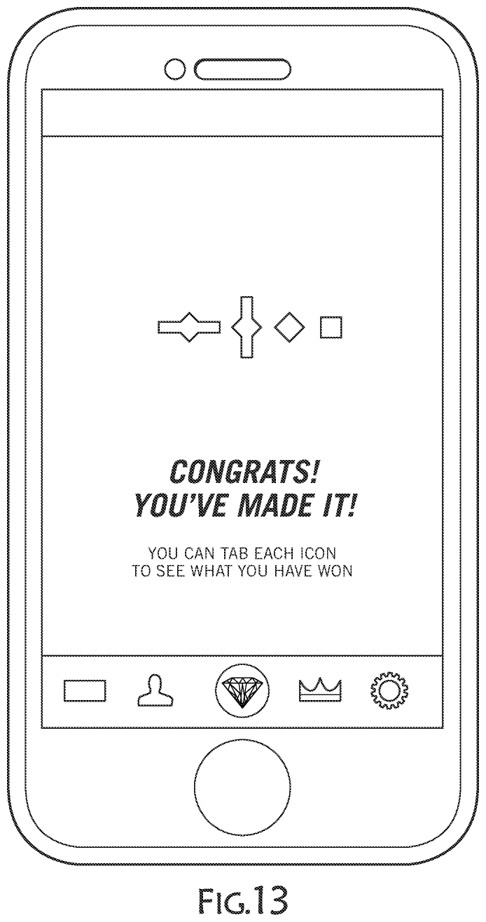

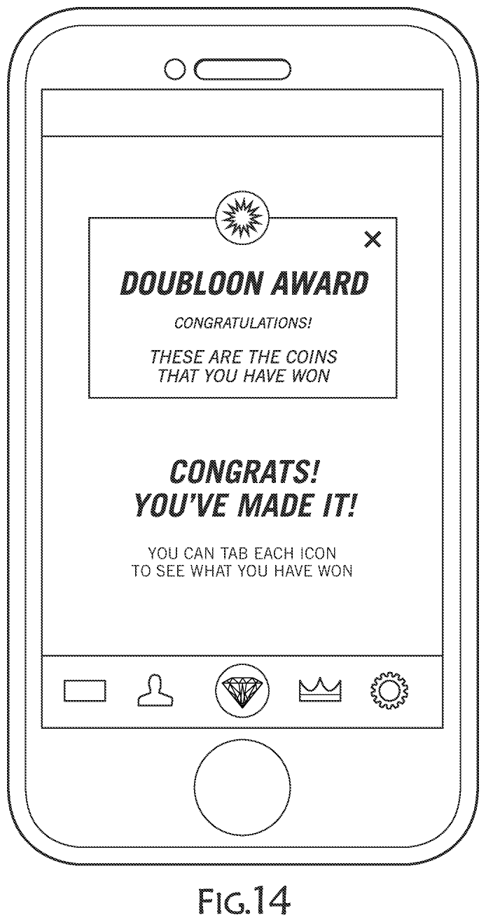

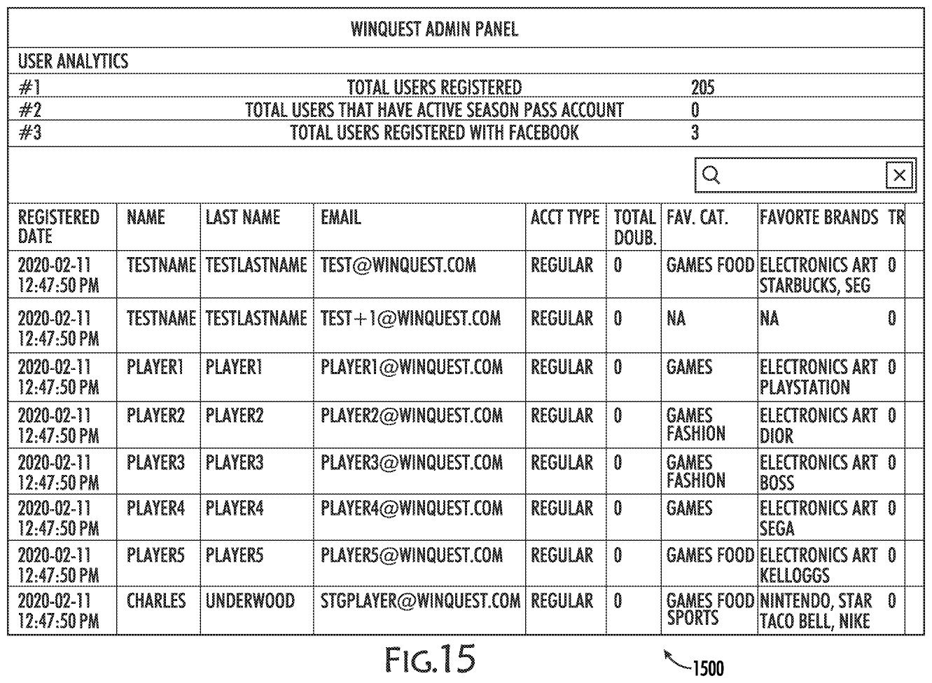

Turning now to FIGS. 10-15, example embodiments of a user interface and administration page is disclosed. The various examples include aspects of features of mini games such as trivia, scratch offs, surveys, as well as an augmented reality treasure hunt, that in of itself may include various mini games in which users may accumulate points through the experience or through the four square decision matrix questions. In other aspects, the staging of the augmented reality game, along with provisioning objectives and rewards is disclosed. Within the interface user stored credentials such as a unique key for a user ID, a user name, user profile status (online, offline, do not disturb), user game history, user rewards total, user coordinates, user credit card information, user age, user sex, user date of birth, and other user provided credentials may be established for supporting operations of the augmented reality game. Such credentials and information may be shared with retail merchants or may aid in the delivering of discount coupons or other rewards to retail merchant stores. Further, a GPS module on the mobile computing device may synchronize with the augmented reality game objectives and retail establishments to provide real time rewards and discounts, including games and mini games based on interaction with the retail merchants.

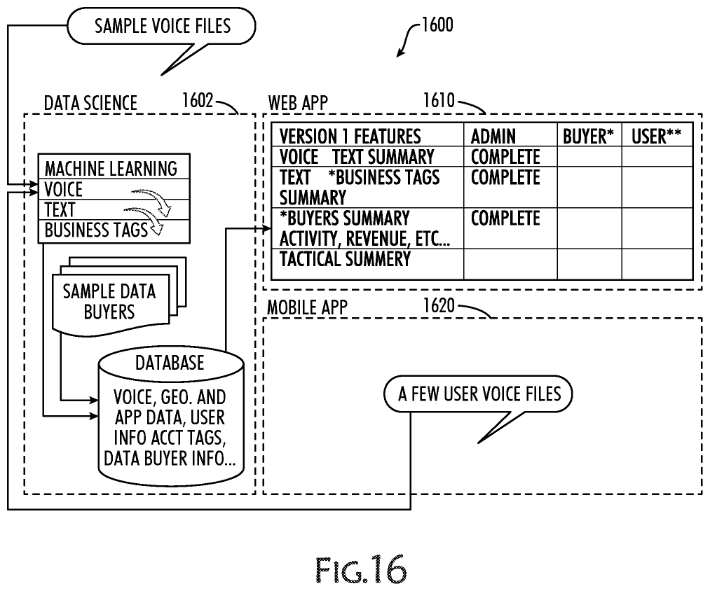

Referring now to FIG. 16, illustrating an example of data flow and processing for a mobile application, such as an augmented reality game. Data input, such as voice files, or other input such as responses to the four square decision matrix are processed into text and labeled, wherein they are stored and configured with tags or otherwise grouped or clustered into specific areas, also known as business tags. Such technologies as natural language processing using standardized libraries may be used or advanced technologies incorporating additional text to speech conversion such as semantic network or language networks may be used.

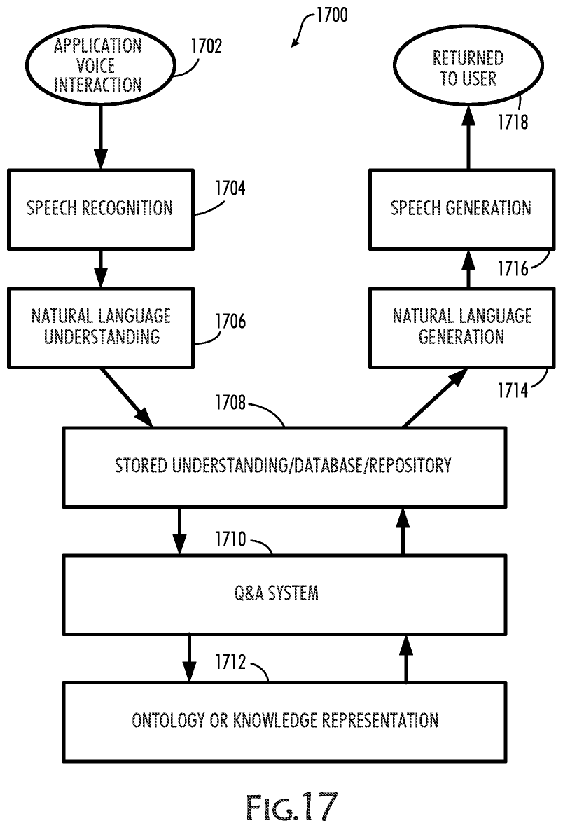

Turning now to FIG. 17, illustrating an example of a flow chart and basic interaction of natural language processing for a mobile application, such as an augmented reality game. In the example, speech is acquired through a microphone on a device, wherein the device may be a smart phone, smart glasses, AR glasses, a smart watch, or any other device that possesses the hardware to acquire voice, either through a microphone or other hardware equipment. The user voice is acquired and the speech is parsed and tagged utilizing a set of standardized NLP libraries along with custom software that allows for identification of items affiliated with the mobile game, including tagging brand, hobby, interest, and other categories.

The tagged speech forms a corpus and the corpus is stored and utilized in further modeling. Next, natural language understanding parses the corpus utilizing a lexicon and grammar rules, to break sentences down to internal representation. Thus, the goal of natural language understanding is to form an ontology. Further, logical inference may be applied to the corpus, utilizing predicate knowledge. Next, the logic and understanding is stored, a Q&A system is modeled and attempts to answer the elected speech question, often times this involves the incorporation of the four square decision matrix, wherein an answer from the user derives a response of the answer and may present output speech regarding an additional follow up question from the four square decision matrix. Q&A software in this regard is tailored or customized to the four square decision matrix, in other aspects, the Q&A software may be tied to and specialized for the geohunt or treasure hunt, and in further aspects, the Q&A and resulting ontology may serve as additional data collection sources beyond the four square decision matrix, including acquiring dialect, or regional understanding, as well as understanding of speech with regard to specific brands or products or interests.

Continuing in FIG. 17, the ontology formed provides responses to the questions or responses, typically found within the four square decision matrix, and generates speech output through a speaker, or over a connection such as Bluetooth to an audio producing device, wherein the user is presented with the response to the question presented. The process repeats itself and may be utilized alongside the treasure hunt or with a variety of mini applications or games within the mobile application.

### Virtual Scratch Off Tickets

In some embodiments, rather than displaying static game parameters, which may be blocked and then unblocked, the dynamic virtual scratch card gaming system displays one or more pre-recorded, or pre-captured, videos. After game play is initiated by a player, playback of the one or more pre-recorded videos may also be initiated to determine a game parameter. For example, in contrast with receiving wagers on live or future sporting events, the pre-recorded videos may be based on the treasure hunts described herein, which allow players to place wagers on a fictitious sequence of events related to the treasure hunt.

In still other embodiments, rather than applying routine, conventional technology to provide a scratch-based game with static-based features, the dynamic virtual scratch card gaming system provides dynamic features implemented through a technology-based approach. For instance, the dynamic virtual scratch card gaming system may implement a plurality of rules to determine a game outcome based on playback of the one or more pre-recorded videos, or one's progress in a treasure hunt. A particular portion of the virtual scratch card may then be associated with a particular game-based outcome, as displayed in the one or more pre-recorded videos. Accordingly, the dynamic virtual scratch card gaming system generates a non-abstract result via a rules-based configuration for a virtual gaming system. In one aspect, a user may play, and place a wager for, a virtual scratch card game from a computing device (e.g., smartphone, tablet device, laptop, personal computer, smartwatch, smart wearable device, virtual reality headset, augmented reality device, etc.). For instance, the computing device may have stored thereon, or may access via a remotely located server, a virtual game application that allows the user to play the virtual scratch card game as part of the overall game play described herein.

In one embodiment, the computing device receives inputs from the user (e.g., via touch screen inputs, button activations, hand gestures, etc.) and displays content associated with operation of the virtual scratch card game (e.g., via an integrated display screen). In another embodiment, the computing device receives inputs from the user, but the content associated with operation of the virtual scratch card game is displayed by, or projected onto, a display screen that is distinct from the computing device. (The projection referred to herein is not limited to operation on a flat screen, or two-dimensional projection, as three-dimensional projection (e.g., via holographic projector) may be alternatively utilized to project the associated content.)

The dynamic virtual scratch card game configuration may include a dynamic virtual gaming system that communicates with the virtual game application on the computing device via a network. In one embodiment, the dynamic virtual gaming system determines the game parameters for the virtual scratch card game that is rendered by the computing device. For example, the dynamic virtual gaming system may have a processor that utilizes an RNG to randomly select a plurality of pre-recorded, actual VS video segments. Further, the processor may utilize the RNG to randomly select positions on the virtual scratch card game grid.

Further, the dynamic virtual gaming system may be in operable communication with a pre-recorded content database, which may store pre-recorded video clips of skill-based events occurring prior to initiation of the virtual scratch card game, and a 2D overlay database, which may store various overlay data that may be appended to the pre-recorded video clips. After the processor determines an outcome of the virtual game, via execution of game core logic code (e.g., according to the RNG), the processor may determine from the game core logic code that rendering code is to be executed to compose rendering data for playback of the selected video clips and corresponding 2D overlay data. The processor may send the rendering data through the network (computerized, telecommunications, wired, etc.) to the computing device for display at the computing device.

Included as componentry within the dynamic virtual gaming system are the processor, various input/output (“I/O”) devices, a memory device, and a data storage device.

The processor executes various code within the memory device. For instance, the processor retrieves the game core logic code and the rendering code from the data storage device for operation in the memory device.

In particular, the game core logic code allows the processor to operate the virtual scratch card game. For example, the game core logic code may have a rules-based approach that randomly selects content associated with the virtual game for display during the virtual game. Accordingly, the game core logic code may require that random data be obtained from a certified random source (e.g., a particular RNG).

Although the dynamic virtual gaming system is depicted as being distinct from the computing device, the dynamic virtual gaming system, or componentry thereof, may be integrated within the computing device in an alternative configuration.

In some embodiments, a graphical user interface (GUI) is used at the initiation of a virtual scratch card game, and may display a virtual scratch card grid with a plurality of scratch-off blocks. The user may position a pointing indicium (e.g., mouse pointer) over a scratch-off block of interest by activating (e.g., clicking) the pointing the indicium over the scratch-off block of interest.

Further, the GUI may have various, additional interactive features. For instance, the GUI may have a “play” button over which the user may position the pointing indicium to initiate play of the virtual scratch card game. In addition, the GUI may have a “prize table” button over which the user may position the pointing indicium to display a prize structure for the virtual scratch card game.

Moreover, the GUI may display various non-interactive features such as an “amount won” feature that displays the amount won according to the prize table. Additional non-interactive features including, but not limited to, amount wagered may also be displayed.

Activation of the prize table button may result in the display of a window that displays a prize table. For example, the window may be a pop-up window displayed within the GUI, or may be a different window that is rendered for display independently of the GUI.

As an example, the prize table may indicate various prizes, which may be won for certain events that occur within the pre-recorded video clips are displayed after activation (i.e., virtual scratching) of the scratch-off blocks. For instance, the event of “goal” appearing within a certain number of consecutive scratch-off blocks and various orientations (e.g., diagonal, vertical, horizontal) may lead to various prizes. In other words, the prize table may be based not only on the quantity of game parameters occurring as events during playback of the pre-recorded video clips, but also the position of the corresponding scratch-off blocks within a virtual scratch card grid. Alternatively, bonus prizes may be based on the location of winning game parameters within the virtual scratch card grid, or the treasure hunt described herein. In other words, the prize may be based on quantity, but the bonus prize may be based on the location.

Once the user has positioned the pointing indicium over a first scratch-off block and activated (i.e., clicked) the scratch-off block, playback of a randomly selected VS-based video clip may be initiated. Indicia corresponding to the plurality of game parameters may be obtained from the 2D overlay database.

Subsequently, the user may select additional scratch-off blocks until all of the remaining scratch-off blocks are revealed, or until a time limit has been reached. In one embodiment, the end of the video clip is displayed without further playback so that the user is able to determine the game parameter (e.g., goal or miss) per scratch-off block. In another embodiment, playback of each of revealed scratch-off blocks is reiterated through so that the user may continue to view the action in various scratch-off blocks. In yet another embodiment, after the action has completed, the game parameter associated with a particular scratch-off block is displayed in a text format (e.g., a display of “goal” without the corresponding pre-recorded video clip) so that the user may identify the game parameters associated with each of the various scratch-off blocks.

The user activating (e.g., clicking) the pointing indicium over a second scratch-off block may activate the scratch-off blocks in a sequence (e.g., left to right), or may randomly activate scratch-off blocks (e.g., the corners first, the middle, etc.). As an alternative, a quick-pick button may be provided to allow a user to have the computing device, or the dynamic virtual gaming system, select the scratch-off blocks for the user.

A virtual scratch grid may be displayed after all of the scratch-off blocks have been revealed. In the illustrated example, the game parameter events corresponding to the pre-recorded video clips resulted in a winning row of scratch-off blocks indicating goals.

In yet another embodiment, the user does not have to select one scratch-off box at a time with the pointing indicium. For example, the user may position the pointing indicium over a simultaneous play button to initiate simultaneous playback of all of the pre-recorded video clips corresponding to the scratch-off blocks. In one embodiment, some of the pre-recorded video clips may have a corresponding first duration, whereas others of the pre-recorded video clips may have a corresponding second duration. For example, some of the scratch-off blocks may correspond to pre-recorded videos having a ten second duration, whereas others of the scratch-off blocks may correspond to pre-recorded videos having a three second duration. Therefore, over the ten second play duration, each scratch-off block will reveal a game parameter associated with a prize table. Alternatively, a play all button may allow for the pre-recorded video clips to be played in a sequence, rather than all being played concurrently.

The virtual scratch card grid can allow for dynamic features (e.g., playback of pre-recorded VS-based game events) to be provided during an online scratch-off game; such dynamic features provide additional levels of excitement for the user.

To obtain an intended outcome determined by the RNG (e.g., a particular horizontal row of scratch-off blocks resulting in a winning outcome), the dynamic virtual gaming system determines the pre-recorded videos with corresponding events. For example, the dynamic virtual gaming system searches through the pre-recorded content database not just for pre-recorded video clips for random VS-based games, but rather for pre-recorded video clips that have events corresponding to the particular game parameter associated with the intended outcome determined by the RNG (e.g., video clips with goals rather than with misses or no goal attempts at all).

In one embodiment, the dynamic virtual gaming system searches through the pre-recorded content database according to one or more event tags to find a plurality of pre-recorded videos that correspond to the intended outcome determined by the RNG (e.g., a horizontal row of videos with goals). The one or more event tags describe events (e.g., goals, misses, no goal attempts) that occur during the one or more video clips stored in the pre-recorded content database. Accordingly, rather than having to have to analyze each video clip for particular events, the dynamic virtual gaming system is able to perform an optimized search for events according to the event tags to quickly find video clips with events corresponding to the virtual scratch card grid. Therefore, the dynamic virtual gaming system improves the functioning of a computer by improving the search time for dynamic features to be positioned within the virtual scratch card grid.

Moreover, the dynamic virtual gaming system can improve the functioning of a computer by improving processing speed via the processor. Instead of expending computing resources on analyzing each video clip for compliance with game parameters that match the intended outcome to be displayed in the virtual scratch card grid, the processor may perform a database command to perform a filtered search only through video clips with the corresponding events. Memory requirements are also reduced because the processor only analyzes video clips corresponding to the event tags that match the intended outcome for display in the virtual scratch card grid.

Thus, the dynamic virtual gaming system may randomly determine an outcome of a virtual scratch card game that includes events, search a database for pre-recorded video clips encompassing those events according to event tags, and display the pre-recorded video clips to the user upon activation of scratch-off blocks.

The virtual scratch card grid being rendered on a touch-screen computing device. For example, the virtual scratch card grid with the unrevealed scratch-off blocks can be displayed on a tablet device. The user may swipe a finger on the display screen of the tablet device to activate the plurality of scratch-off blocks.

In one embodiment, the dynamic virtual scratch card game configuration may establish a predetermined scratch-off threshold for initiating playback of a pre-recorded video clip corresponding to a scratch-off block. For example, the dynamic virtual scratch card game configuration may determine that playback should not be initiated unless twenty percent of the scratch-off block has been scratched-off (i.e., swiped) via the touch screen. Accordingly, the dynamic virtual scratch card game configuration may encourage the user to quickly swipe the scratch-off block to avoid missing out on the associated action, but also provide the user with a significant portion of the video clip to view prior to completion of the video clip if the user does not fully swipe the scratch-off block prior to completion of the video clip.

As an example, the user may play the game according to one or more virtual game rules displayed in a virtual game rules window. For instance, the virtual game rules may specify that the user may select only three out of six scratch-off indicia for activation. The computing device then displays the pre-recorded video clips corresponding only to those activated scratch-off indicia, not the other scratch-off indicia. In one embodiment, the processor randomly determines the outcome of the virtual scratch-off game and selects only three pre-recorded video clips to match that outcome of the virtual scratch-off game. In another embodiment, the processor randomly determines six possible game parameters (e.g., goal or miss) and associates each game parameter with one of the virtual scratch-off indicia. The user then, at least partially determines, what prize, if any, is won based on the selection of three virtual scratch-off indicia. For example, four of the virtual scratch-off indicia may be associated with a “goal” event in the corresponding pre-recorded video clips, whereas two of the virtual scratch-off indicia may be associated with a “miss” event in the corresponding pre-recorded video clips. The user may win a larger prize if the three selected virtual scratch-off indicia all correspond to “goals,” as opposed to some only corresponding to “goals.”

The various quantities of virtual scratch-off indicia, prizes, etc. may vary from those illustrated and discussed, which are provided only as examples.

In some embodiments, the selected virtual scratch-off indicium may be augmented with a game parameter feature (e.g., text/imagery indicating “goal”) based on an event displayed by a pre-recorded video clip. In other words, rather than displaying 2D overlay data (e.g., team names, game location, event outcome, etc.) over the pre-recorded video clip, the computing device may instead display 2D overlay data over, or in proximity to, a scratch-off indicium. As yet another alternative embodiment, the computing device may display the 2D overlay data in both instances--over a pre-recorded video clip and a scratch-off indicium.

Further, in another embodiment, the computing device may augment a prize table indicium illustrated in the prize table upon an event occurring during playback of a pre-recorded video clip. For example, as a result of the event being a “goal” that occurs during the playback of the pre-recorded video clip, the computing device may add imagery (e.g., shading, additional colors, etc.) to the prize table indicium corresponding to one goal. As the virtual scratch-off game progresses, the computing device may adjust (remove, add, and/or modify) augmented features to represent the current state of the virtual scratch-off game.

After selection and activation of various virtual scratch-off indicia, corresponding video clips can be displayed prior to completion of the virtual scratch-off game; for ease of illustration, only the final virtual scratch-off card may be displayed after such multiple iterations.

Although the computing device may include a computer monitor displaying the pointing indicium, which may be in operable communication with a device encompassing the processor, the computing device may alternatively receive touch-screen inputs (e.g., via a tablet device). In one example, the video clips are of a soccer game (showing goals and misses), but this is merely an example, as a variety of other types of skill-based games may be utilized for pre-recorded content in the pre-recorded content database.

A computer is herein intended to include any device that has a general, multi-purpose or single purpose processor as described above. For example, a computer may be a PC, laptop computer, set top box, cell phone, smartphone, tablet device, smart wearable device, portable media player, video player, etc.

### Augmented Reality Advertisements

In one embodiment, a database is set up with customized user information, matching merchants to users based on hobby interests, user data, including user location, and brand interests, and augmented reality advertisements, in the form of videos, interactive images, and the like, can be displayed on the user's computer, laptop, and/or phone. In some aspects, this includes an augmented reality billboard, where a user can press on a logo and be directed to a merchant website, and/or download a coupon code to a user profile, where the user can then access the coupon to purchase goods from the merchant.

In augmented reality (AR) the user is provided with additional computer generated information within the data collected from real life that enhances their perception of reality. For example, in architecture, VR can be used to create a walk-through simulation of the inside of a new building; and AR can be used to show a building's structures and systems super-imposed on a real-life view. Another example is through the use of utility applications. Some AR applications, such as Augment, enable users to apply digital objects into real environments, allowing businesses to use augmented reality devices as a way to preview their products in the real world. Similarly, it can also be used to demo what products may look like in an environment for customers, as demonstrated by companies such as Mountain Equipment Co-op or Lowe's who use augmented reality to allow customers to preview what their products might look like at home through the use of 3D models.

Using this approach, one can provide users with a virtual reality or augmented reality billboard, with access to coupons, discount codes, giveaways, and the like, for example, through the camera portion of a phone or a tablet. When images are clicked on, that can reveal a merchant-affiliated coupon that can be redeemed. The coupon can be sent to the user's account for later redemption. In one embodiment, the coupons can be sent from a merchant to a user when the user is within a predetermined distance from the merchant's store.

Various embodiments of the invention have been described in fulfillment of the various objectives of the invention. It should be recognized that these embodiments are merely illustrative of the principles of the present invention. Modifications, additions, or omissions may be made to the systems, apparatuses, and methods described herein without departing from the scope of the disclosure. For example, the components of the systems, apparatuses may be integrated or separated. Moreover, the operations of the systems and apparatuses disclosed herein may be performed by more, fewer, or other components and the methods described may include more, fewer, or other steps. Additionally, steps may be performed in any suitable order.

Therefore, the following is claimed:

1. A method for collecting user data through an augmented reality geolocation treasure hunt game, the method comprising:
deploying an augmented reality geolocation treasure hunt game as a mobile application on a mobile computing device;
initiating the augmented reality geolocation treasure hunt game, wherein initiating places an instance of the augmented reality geolocation treasure hunt game into memory on the mobile computing device and loads user parameters of at least user location, user profile status, and user stored credentials;
generating, by the augmented reality geolocation treasure hunt game, a series of questions that when answered provide clues to a location of a next objective on the geolocation treasure hunt game, wherein the series of questions is in a format of a four square decision matrix;
collecting, by responses to the series of questions within the four square decision matrix of the augmented reality geolocation treasure hunt game, user information from the responses to the series of questions;
generating, by the responses to the series of questions within the four square decision matrix of the augmented reality geolocation treasure hunt game, additional questions based on collected user information from the responses;
coordinating, by a GPS module on the mobile computing device configured with the mobile application, user coordinates in relation to an objective of the augmented reality geolocation treasure hunt game; and
granting access to a reward based on the user's coordinates at a reward location that was provided by the responses to the series of questions within the four square decision matrix of the augmented reality geolocation treasure hunt game.

2. The method of claim 1, further comprising issuing coupons to merchant retail stores through the augmented reality geolocation treasure hunt game.

3. The method of claim 2, wherein the merchant retail store applies a discount on goods and or services.

4. The method of claim 1, wherein coordinating with the GPS module on the mobile computing device further coordinates issuance of alerts to close proximity merchant retail stores that match the responses from the four square decision matrix.

5. The method of claim 1, further comprising alerting to additional rewards based on the user coordinates and responses to the four square decision matrix.

6. The method of claim 1, wherein collecting user information from the series of questions is collected utilizing speech to text automatic speech recognition technology.

7. A system for collection of user data within an augmented reality game, comprising:
a mobile computing device, comprising:
a processor, configured to process an augmented reality game;
a graphics processing unit, configured to process visual rendering of an object on a screen of the mobile computing device;
a depth sensor, configured to measure depth and distance;
a proximity sensor, configured to measure how close or far away the object is;
an accelerometer, configured to detect changes in velocity;
a light sensor, configured to measure light intensity and brightness;
an configurable augmented reality software application, configured on the mobile computing device, wherein the configurable augmented reality software application is configured with a question and response four square decision matrix;
a distributed computing environment, configured to receive and transmit instructions and deploy the configurable augmented reality software application; and
a networked computer, configured to communicate to the distributed computing environment.

8. The system of claim 7, further comprising a relational database configured to receive responses from the configurable augmented reality software application, configured on the mobile computing device, wherein the responses comprise answers to a four square decision.

9. The system of claim 7, further comprising a plurality of mobile computing devices, wherein the plurality of mobile computing devices is configured with the configurable augmented reality software application and in communication with one another.

10. The system of claim 7, wherein the mobile computing device further comprises a LIDAR unit.

11. The system of claim 7, wherein the mobile computing device is configured to eyeglasses.

12. The system of claim 7, wherein the mobile computing device is configured to a wrist watch.

13. The system of claim 7, wherein the mobile computing device further comprises a rear facing camera.

14. The system of claim 7, wherein the mobile computing device further comprises GPS tracking.

15. The system of claim 7, wherein the distributed computing environment is configured to a cloud network environment.

16. A method for collecting data through a mobile application, comprising:
initiating a mobile application on a user mobile computing device;
presenting a user with a four square decision matrix within the mobile application;
selecting by the user at least one option from the four square decision matrix;
collecting information from a user selection, wherein collecting acquires at least a user's geolocation and a selection made from the four square decision matrix;
generating a new question based on the user selection and previous selections by the user on the four square decision matrix; and
rewarding the user after a set count of responses.

17. The method of claim 16, wherein collecting information from the user selection includes product preference data.

18. The method of claim 16, wherein collecting information from the user selection includes brand preference data.

19. The method of claim 16, wherein collecting information from the user selection includes hobby data.

20. The method of claim 16, wherein collecting information from the user selection includes user interest data.
